(19) United States
(12) Patent Application Publication
(10) Pub. No.: US 2016/0071206 A1
(43) Pub. Date: Mar. 10, 2016

(54) Implementation of a Service Platform for an Online Peer-to-Peer (P2P) Lending Transaction

(71) Applicant: Alexander Danieli, Sydney (AU)

(72) Inventor: Alexander Danieli, Sydney (AU)

(21) Appl. No.: 14/476,743

(22) Filed: Sep. 4, 2014

(51) Int. Cl. G06Q 40/02

(52) U.S. Cl. CPC G06Q 40/025

(57) ABSTRACT

Disclosed is a system and method for implementing a service platform to provide one or more services for an online loan transaction through an instance of a service facilitator engine. The services provided by the service facilitator engine enhance the user's experience when engaged in an online loan transaction or online P2P lending transaction. Further, the service facilitator engine ensures a safe and secure platform for transferring the loan amount to the registered borrower. The service platform tracks the repayment schedule of the registered borrower and credits rating based on the tracking information. Based on the credit rating of the registered borrower, registered lenders can authorize the registered borrowers to avail the loan facility.

### BACKGROUND

The invention relates to facilitating services for an online loan transaction and more specifically about implementing a service platform to perform an online loan transaction by availing services provided by a service platform that enhances the user's experience while engaged in the online loan transaction. Currently, there are some web-based loan transaction systems that consider various potential lenders and potential borrowers on the web and a loan transaction is initiated by matching these potential lenders and borrowers. Further, some of the web-based loan handling systems determines the lenders based on the profile of the borrower information and the project information or by placing a bid based on the desired loan amount and the desired loan terms of a borrower. However, the existing web-based loan transaction systems do not provide services to the users (involved in the loan transaction) with intent to enhance the user's experience while engaged in the loan transaction. Additionally, this invention has a system to track the credibility of the borrower by checking the loan transaction history of the borrower, as well as determining the level of trust a borrower has based on their activity on the service facilitator's web-based platform. Based on the credibility and trust of the borrower, indicated by the service facilitator's platform, the lender can authorize the borrower to avail the loan facility. Also, as the number of lenders and borrowers for the on line loan transaction is increasing on the web site; there is a need for a platform that enables safe and secure loan transaction within the network.

In light of the above discussion, there is a need for a platform that ensures safe and secure online loan transaction with certain services offered to enhance the user's experience in handling the online loan transaction, specifically for Peer-to-Peer (P2P) lending.

### SUMMARY

The invention is related to a system and method for implementing a service platform to provide one or more services through a service facilitator after establishing an online loan transaction between one or more registered lenders and one or more registered borrowers to enhance user's experience while engaged in an online loan transaction within a network. The method comprises of establishing an online transaction between registered lenders and registered borrowers based on the terms and conditions agreement accepted between the registered lenders and the registered borrowers. Furthermore, the method comprises of creating an instance of the service facilitator for the online loan transaction established between the registered lenders and the registered borrowers. Additionally, the method comprises of activating one or more services offered by the service facilitator to one or more registered lenders after transferring the loan amount from the registered lenders to the registered borrowers as per the agreement decided for the online loan transaction. Hence, the method comprises of availing one or more services provided by the service platform that is created for the online loan transaction.

Other features and advantages of the embodiments herein will become readily apparent from the following detailed description taken in conjunction with the accompanying drawings.

### BRIEF DESCRIPTION OF THE DRAWING(S)

FIGS. 1a and 1b, according to an embodiment of the present invention, depicts an implementation of a Service facilitator platform used to enhance the user's experience while engaged in an online loan transaction.

FIG. 2, according to an embodiment of the invention, is a flow-chart that explains the process of performing an online loan transaction within a network by using a service facilitator engine.

FIG. 3, according to an embodiment of the invention, is an overview of components required to implement the service facilitator platform for performing an online loan transaction within the network by using the service facilitator's engine.

### NOTE: DON'T USE SCREENSHOTS. PLEASE CHANGE TO DIAGRAMS

FIG. 4, according to an embodiment of the present invention, is a screen mock-up of the service facilitator engine that is initialized for the online loan transaction.

FIGS. 5, 6, 7 and 8, according to an embodiment of the present invention, are the screen mock-ups of the services provided by the service facilitator engine that is initiated for the online loan transaction.

### FIGURES

### Reference Numerals

100—Service facilitator platform
101, 101a, 101b—Client systems
102—A server system
103—A service facilitator engine
301—Authorization module
302—Service facilitator initializing module
303—User interface module
304—Repayment scheduling module
305—Displaymodule
306—Storage module
307—Credit rating module
308—Controlling module

### DETAILED DESCRIPTION

In the following detailed description, references are made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

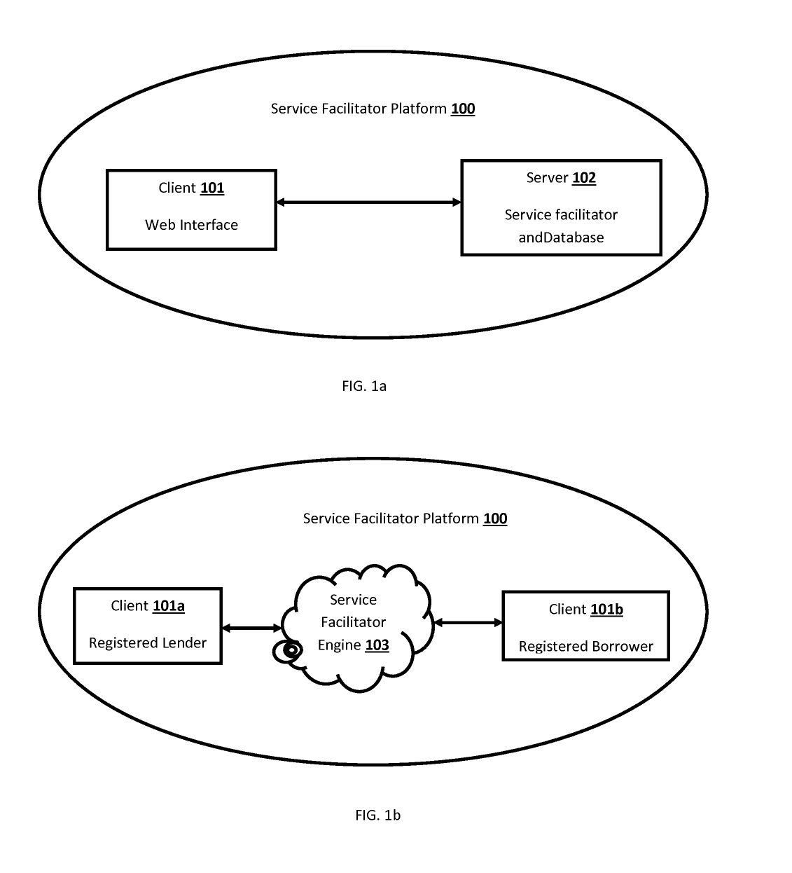

Referring to FIGS. 1a and 1b, depicts an implementation of a Service facilitator platform 100 that provides one or more services for the users to enhance the user's experience while engaged in an online loan transaction or an online P2P lending transaction. As depicted in FIG. 1a, the service facilitator platform 100 is implemented based on a client-server technology. The client system 101 is configured to provide a web interface that accepts user inputs such as terms and conditions for the loan transaction, repayment schedule, effective date of the loan agreement and the like. Based on these inputs and agreement determined between the users involved in the online loan transaction, an instance of a service facilitator is initialized. In an embodiment, a server system 102 is configured to support the service facilitator engine 103 that provides one or more services for the online loan transaction established between the registered lender and the registered borrower. Also, a database is supported on the server system 102 to store the details of the loan transaction. In an embodiment, the web interface of the client system 101 can be supported on a computer system or a mobile device. As depicted in FIG. 1b, the service facilitator engine 103 supported in the server system 102 is initialized only for the registered users engaged in the loan transaction. In an embodiment, as the service facilitator engine 103 is initialized for the registered users for a loan transaction, all the activities associated with the loan transaction are performed through the initialized service facilitator engine 103.

In an embodiment, one or more services offered by the service facilitator engine 103 are activated after the registered lender transfers the loan amount to the registered borrower. In an embodiment, the processed data and the data associated with the loan transaction are stored in the database supported on the server system 102.

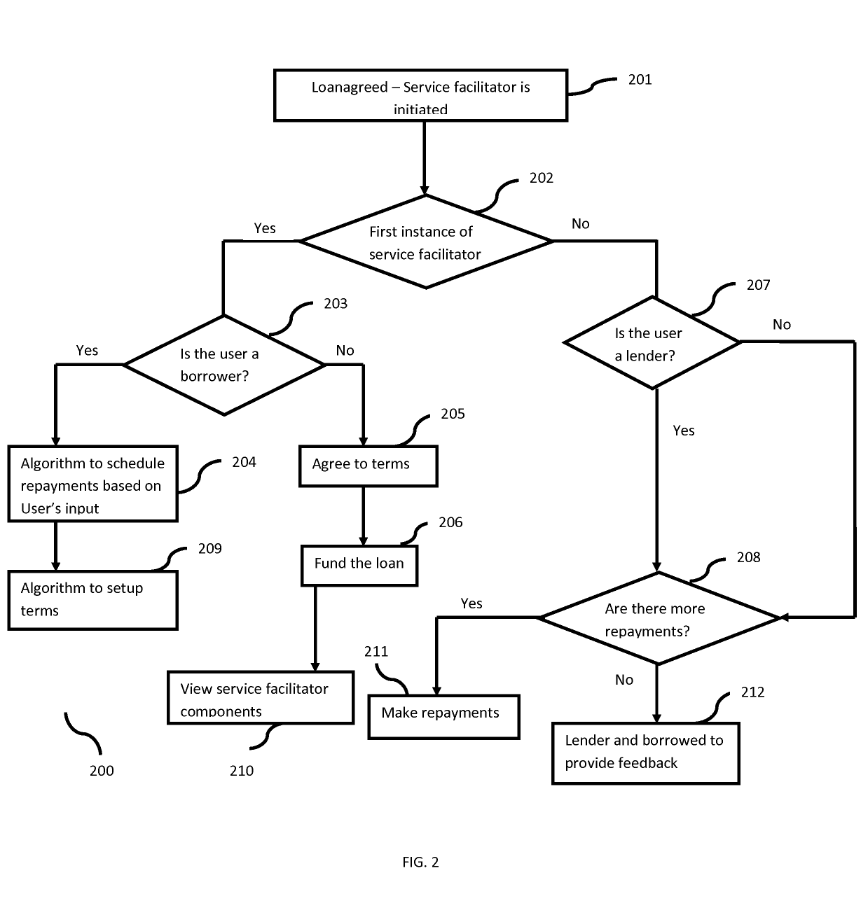

Referring to FIG. 2, depicts a flow-chart that explains the process of performing an online loan transaction within a network by using an instance of a service facilitator engine 103. Initially, at step 201 a loan agreement between a lender and a borrower is agreed upon. As the agreement is decided between the two registered parties (registered lender and registered borrower), an instance of the service facilitator engine 103 is initiated for the loan transaction. In an embodiment, registered lenders of the loan can either opt to publish the loan availability through the web interface or make a loan offer based on the request sent by the registered borrower. Based on the loan requirement, the registered borrower can accept the available loan facility by entering into an agreement with the registered lender. As the registered borrower accepts the available loan facility, an instance of the service facilitator engine 103 is initialized for the loan transaction. At step 202, the method 200 checks if the instance of the service facilitator engine 103 is initialized for the first time. If the instance of the service facilitator engine 103 is initialized for the first time, then at step 203, the method 200 determines if the user is a borrower of the loan. At step 204, if the method determines the user to be a registered borrower of the loan then an algorithm is initiated to schedule the repayment plan that is based on the borrower's input. Further, at step 209, an algorithm is used to setup the terms and conditions for the established online loan transaction based on the repayment plan schedule provided by the registered borrower. Alternatively, if the method determines the user to be a registered lender, at step 205, the registered lender agrees to the terms decided by the two parties and at step 206 the registered lender funds the loan amount to the registered borrower. After the registered lender funds the loan amount to the registered borrower, at step 210, the method 200 allows the users to view various services available through the service facilitator engine 103 for handling the online loan transaction. For example, the services that can be provided to the users involved in the loan transaction are: tracking the repayment schedule, managing terms and agreement, providing online messaging support, providing credit rating for the registered borrower based on the repayments schedule followed by the registered borrower and the like. Alternatively, at step 202, if the method 200 determines that the service facilitator engine 103 is already initialized for the online loan transaction and the user is accessing an existing instance of the service facilitator engine 103 to track the initialized service facilitator, then at step 207, the method 200 checks if the user is the registered lender. If the method 200 determines that the user is the registered lender when the service facilitator engine 103 is initialized, then at step 206 the method 200 allows the registered lender to fund the loan amount to the registered borrower. After the registered lender funds the loan amount to the registered borrower, at step 210, the method 200 allows the registered lender to view various services provided by the initialized service facilitator engine 103. However, if the method 200 determines that the user is the registered borrower for the established online loan transaction, then at step 208, the method 200 checks for the loan repayment details of the registered borrower. If the registered borrower is yet to complete the repayment amount, at step 211, the method 200 instructs the borrower to complete the repayment amounts as per the agreed schedule. However, if the registered borrower has completed paying the repayment amounts, at step 112, the method 200 instructs the parties involved in the online loan transaction to provide feedback about the complete process of the online loan transaction.

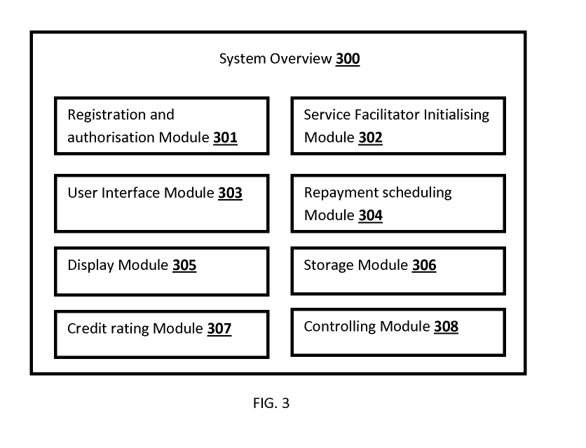

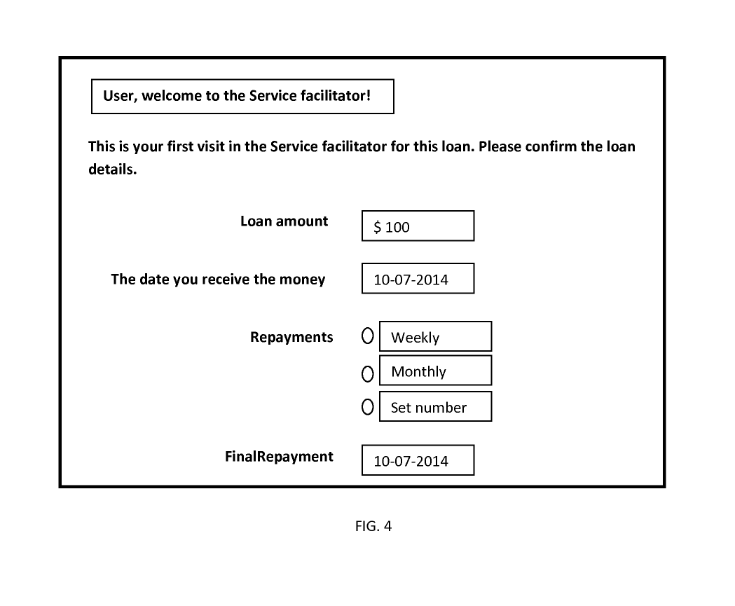

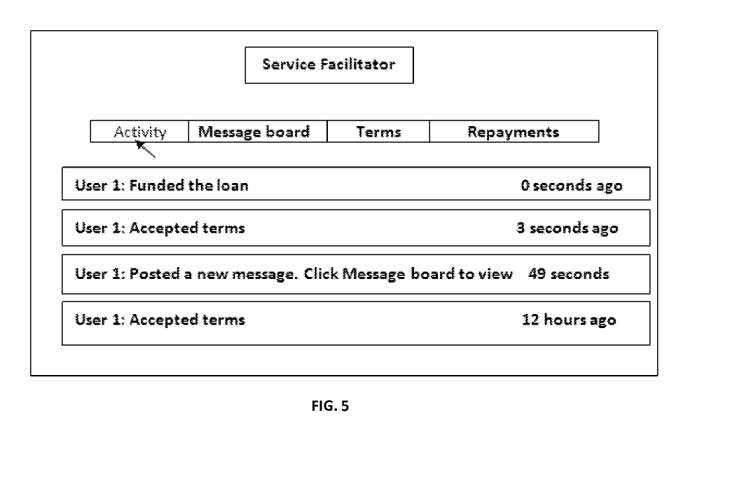

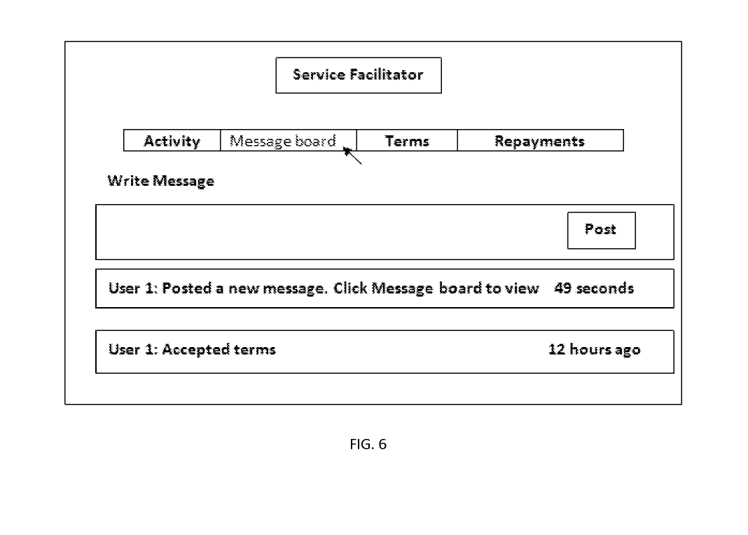

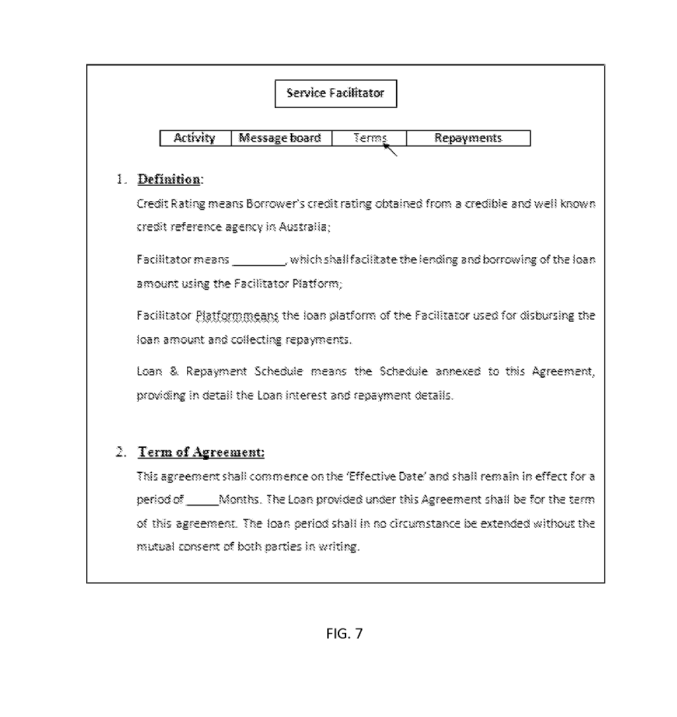

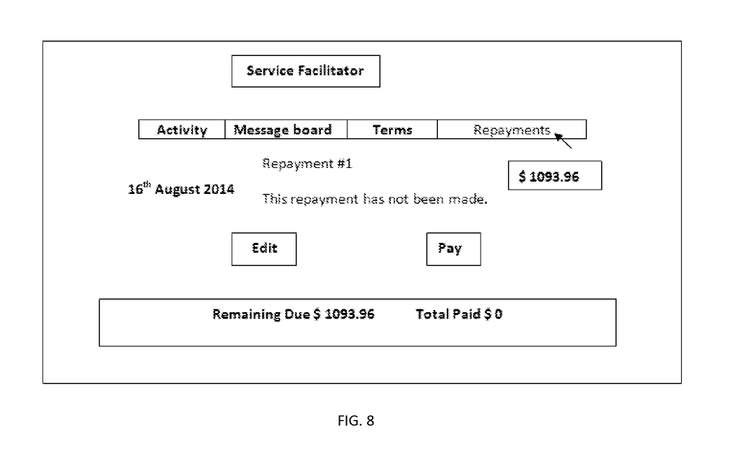

Referring to FIG. 3, depicts a system overview 300 that enables the method to perform an online loan transaction within the network by using the service facilitator engine 103. The system comprises of the following components: a Registration and authorization module 301, a Service facilitator initializing module 302, a User interface module 303, a Repayment scheduling module 304, a Display module 305, a Storage module 306, a Credit rating module 307, and a Controlling module 308. In an embodiment, the Registration and authorization module 301 is configured to register the users for engaging in an online loan transaction activity through the web interface and to authorize the registered borrowers by rating credits based on the registered borrower's loan transaction history. The credit rating of the registered borrower's loan transaction history is based on the reliability of the registered borrower in repaying the loan amount. In an embodiment, the Service facilitator initializing module 302 is configured to initialize an instance of the Service facilitator engine 103 for an online loan transaction after the registered lender and the registered borrower have agreed to the terms and conditions of the loan. As the Service facilitator engine 103 is initialized for the online loan transaction, all the transactions of the loan are performed through the initiated Service facilitator engine 103. For example, the repayment details of the loan transaction can be viewed through the services offered by the Service facilitator engine 103. In an embodiment, the User interface module 303 is configured to allow the users/parties involved in a loan transaction to provide loan related information for the initiated Service facilitator engine 103. For example, the terms and conditions required for an agreement between the parties involved in the loan transaction can be fed into the Service facilitator engine 103 through the User interface module 303. In an embodiment, the Repayment scheduling module 304 is configured to support an algorithm that schedules the loan repayment mode as per the agreement decided between the users. The algorithm sends remainders to the users based on the repayment schedule. For example, if the registered borrower has agreed to pay the loan amount with a fixed interest rate in monthly installments then the algorithm notifies the borrower every month for payment of the loan amount. In an embodiment, the Display module 305 is configured to display the loan transaction details to the user. For example, the terms and conditions agreed by the loan transaction parties can be viewed through the User interface module 303. In an embodiment, the Storage module 306 is configured to store the processed data and the data associated with the online loan transaction. In an embodiment, the Credit rating module 307 is configured to rate the credit of the registered borrower by tracking the repayment schedule captured in the transaction history of the registered borrower. In an embodiment, the registered borrower can get the rating inputs from various social networking sites such as Facebook, Google, and the like. For example, if the registered borrower has taken loan many times online through the web interface and has repaid the loan amount as per the schedule during the loan transactions, then the credit rating for the registered borrower increases. Based on the credit rating available for the registered borrower, the credibility of the registered borrower increases and the registered lenders can authorize the registered borrowers to avail the loan. In an embodiment, the Controlling module 308 is configured to perform additional functionalities such as transferring content across various modules, gathering feedback from the users who are involved in the loan transaction, checking for different types of services provided by the service facilitator engine and the like.

Referring to FIG. 4, depicts a screen mock-up of the service facilitator engine 103 that is initialized for the online loan transaction. The user interface that is captured as the screen mock-up allows the loan transaction involved parties to specify the loan details. After entering the loan details in the user interface, the user needs to select the confirm button to confirm the details. Based on the details provided by the user, the repayment scheduling algorithm will automatically schedule the repayments for the loan based on the user input. It also sends reminders to the users for repaying the loan amount. Referring to FIGS. 5, 6, 7, and 8 depict various screens associated with different services provided by the service facilitator engine 103 that are initiated for the loan transaction. FIG. 5, depicts an Activity screen that provides information about the activities/events occurring with respect to the loan transaction for which the service facilitator engine 103 is initiated. For example, the Activity screen displays information about the activities/an event regarding the loan transaction such as the arrival of a new message related to the loan transaction, notifies the parties involved when terms and conditions related to the loan transaction are accepted, notifies the parties involved when repayments are made and the like. FIG. 6, depicts a Message board screen that allows the user to view or edit the messages sent by the parties involved in the loan transaction for which the service facilitator engine 103 is initiated. For example, the registered borrower can send a message to the registered lender through the Message board service. FIG. 7, depicts a Terms screen that allows the user to view the terms and conditions determined for the loan transaction that is agreed by the parties involved in the loan transaction. FIG. 8, depicts a Repayment screen that displays the details of repayment associated with the loan transaction. The repayment details can be edited through the Repayment screen.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A method for implementing a service platform to provide at least one service through an instance of a service facilitator engine after establishing an online loan transaction to enhance user's experience while engaged in said online loan transaction within a network, wherein the method comprises of:
a) establishing said online loan transaction between at least one registered lender and at least one registered borrower based on the terms and conditions agreement accepted between said at least one registered lender and said at least one registered borrower;
b) creating an instance of said service facilitator engine for said online loan transaction established between said at least one registered lender and said at least one registered borrower;
c) activating said at least one service offered by said service facilitator engine to said at least one registered lender after transferring the loan amount to said at least one registered borrower as per the agreement decided for said online loan transaction; and
d) availing at least one service provided by said service facilitator engine that is created for said online loan transaction.

2. The method as claimed in claim 1, wherein said service facilitator engine ensures a safe and secure online loan transaction established between said at least one registered lender and said at least one registered borrower by using a secured web interface for communication between said at least one registered lender and said at least one registered borrower.

3. The method as claimed in claim 1, wherein said at least one service provided for said online loan transaction is activated for said at least one registered lender only after the loan amount is transferred to said at least one registered borrower as per the agreement decided for said online loan transaction.

4. The method as claimed in claim 3, wherein said at least one service provided for said online loan transaction comprises of scheduling the repayments terms for said online loan transaction, ensuring a secure loan amount transfer, tracking and displaying online activities associated with said online loan transaction, arbitrating said online loan transaction, providing credits to said at least one borrower by tracking the repayment schedule followed by said at least one borrower.

5. The method as claimed in claim 1, wherein an instance of said service facilitator engine created for said online transaction is associated with a unique identifier.

6. A system for implementing a service platform to provide at least one service through a service facilitator engine after establishing an online loan transaction between at least one registered lender and at least one registered borrower to enhance user's experience while engaged in said online loan transaction within a network, wherein the system comprises of a Service facilitator initializing module, a Repayment scheduling module, and a Credit rating module and is configured to:
a) establish said online transaction between said at least one registered lender with said at least one registered borrower based on the terms and conditions agreement accepted between said at least one registered lender and said at least one registered borrower;
b) create an instance of a service facilitator engine for said online transaction established between said at least one registered lender and said at least one registered borrower;
c) activate said at least one service offered by said service facilitator engine to said at least one registered lender after transferring the loan amount to said at least one registered borrower as per the agreement decided for said online loan transaction; and
d) avail said at least one service provided by said service facilitator engine that is created for said online loan transaction.

7. The system as claimed in claim 6, wherein said service facilitator engine ensures a safe and secure online loan transaction established between said at least one registered lender and said at least one registered borrower by using a secured web interface for communication between said at least one registered lender and said at least one registered borrower.

8. The system as claimed in claim 6, wherein said at least one service provided for said online loan transaction is activated for said at least one registered lender only after the loan amount is transferred to said at least one registered borrower as per the agreement decided for said online loan transaction.

9. The system as claimed in claim 8, wherein said at least one service provided for said online loan transaction comprises of scheduling the repayments terms for said online loan transaction, ensuring a secure loan amount transfer, tracking and displaying online activities associated with said online loan transaction, arbitrating said online loan transaction, providing credits to said at least one borrower by tracking the repayment schedule followed by said at least one borrower.

10. The system as claimed in claim 6, wherein an instance of said service facilitator engine created for said online transaction is associated with a unique identifier.
